(19) United States
(12) Patent Application Publication
(10) Pub. No.: US 2022/0410072 A1
(43) Pub. Date: Dec. 29, 2022

(54) WATER PURIFICATION CARTRIDGE SYSTEM AND METHOD

(71) Applicant: PENTAIR, INC., Minneapolis, MN (US)

(72) Inventors: Chuanfang YANG, Saint Paul, MN (US); Yue DING, Suzhou (CN); Xiangyang PAN, Suzhou (CN); Rongyao HAN, Suzhou (CN); Wenming SHEN, Suzhou (CN); Robert CROWDER, Saint Paul, MN (US); Jun ZHANG, Suzhou (CN)

(21) Appl. No.: 17/756,290

(22) PCT Filed: Nov. 20, 2020
(86) PCT No.: PCT/US2020/061538

§ 371 Date: May 20, 2022

(30) Foreign Application Priority Data
Nov. 21, 2019 (CN) 2019220176847
Dec. 6, 2019 (CN) 2019221697305
Jan. 23, 2020 (CN) 2020201455842
Mar. 25, 2020 (CN) 2020102183854
Mar. 25, 2020 (CN) 2020203946482

(51) Int. Cl. B01D 63/10; B01D 61/02; C02F 1/44

(52) U.S. Cl. CPC B01D 63/103; B01D 61/025; B01D 63/107; C02F 1/441; B01D 2313/21

(57) ABSTRACT

A water purification cartridge, and water permeate tubes and end caps for use therewith, are provided. An exemplary water purification cartridge has a central core with at least a first pair of permeate water tubes disposed about a central channel and a membrane assembly wrapped around and covering the central core. The membrane assembly includes at least a first membrane structure wrapped around a first permeate water tube, thereby creating a first permeate water tube assembly, and a second membrane structure wrapped around a second permeate water tube, thereby creating a second permeate water tube assembly. The first and second membrane structures are different. In another embodiment, a water purification cartridge comprises a central core with at least a first pair of permeate water tubes and a membrane assembly wrapped around and covering the central core, with each of the permeate water tubes having a generally tear-drop cross-sectional shape.

### FIELD

This disclosure relates to a water purification device, and particularly to a central tube and membrane structure for a cartridge for a water purification device, such as a reverse osmosis filter.

### BACKGROUND

With the development of society, water purification equipment has gradually become popular in thousands of households. For the water purification equipment based on reverse osmosis technology, the reverse osmosis (RO) membrane filter cartridge plays an important role. Different manufacturers adopt different reverse osmosis membrane filter cartridge technologies and produce such cartridges with different structures.

For reverse osmosis membrane filter cartridges, the life and water recovery of the cartridges can be obviously prolonged by using the structure of a side-flow for feed water, instead of direct flow for regular RO cartridges. The structure of existing side-flow water purification RO cartridges adopts a central tube, which is divided into two parts, one being a permeate water tube and the other one being a concentrate/waste water tube. Because the tube is divided and only half is devoted to the permeate water, only a single membrane can be rolled inside the cartridge (creating a “single leaf” structure), thereby limiting the permeate flow of the filter. Such a single leaf side-flow membrane cartridge has some disadvantages due to the fact that all of the feed water and all of the permeate water travels in a spiral path through this single leaf. This leads to higher pressure drops for both feed and permeate water which reduces the trans-membrane pressure and consequently the permeate flow and sometimes the selectivity. This becomes more critical as the element diameter increases, since the single leaf becomes correspondingly much larger.

There is also a side-flow water purification membrane structure which uses a number of permeate water tubes connected with membrane assemblies to form a central tube (a “multi-leaf” structure). In such a structure, the permeate tubes are generally cylindrical in shape and are placed together to form a central tube. Due to the cylindrical shape of the permeate tubes, the central tube formed therefrom has a large gap in the middle which cannot create a stable support for the membrane. Further, in existing multi-leaf side-flow water purification structures, the membranes wrapped around each of the permeate water tubes is the same. As a result, outer layers of adjacent membranes overlap one another to form an overall layer having an unnecessarily large thickness. The resulting product therefore has an unnecessarily large diameter and filtration efficacy is reduced.

A need exists for a side-flow water purification structure which addresses one or more of these concerns.

### SUMMARY

Some embodiments provide a water purification cartridge comprising a central core comprising at least a first pair of permeate water tubes disposed about a central channel; and a membrane assembly wrapped around and covering the central core, the membrane assembly comprising at least a first membrane structure wrapped around a first permeate water tube, thereby creating a first permeate water tube assembly, and a second membrane structure wrapped around a second permeate water tube, thereby creating a second permeate water tube assembly, wherein the first and second membrane structures are different.

In some embodiments, the first membrane structure comprises a first functional layer, a filtering layer and a second functional layer. In some embodiments, the first and second functional layer are different. In some embodiments, the first functional layer is a permeate water carrier layer and the second functional layer is a feed water mesh spacer layer. In some embodiments, the filtering layer comprises a substrate layer and a separation layer. In some embodiments, the second membrane structure comprises a first functional layer and a filtering layer. In some embodiments, the second membrane structure consists essentially of the first functional layer and the filtering layer.

In some embodiments, the water purification cartridge further comprises a first end cap on a first end of the cartridge and a second end cap on the second end of the cartridge. In some embodiments, at least one of the end caps has a main body having a front side and a rear side, a permeate water outlet and a concentrate water outlet on the front side of the main body, and a permeate water inlet and a concentrate water inlet on the rear side of the main body, wherein the concentrate water inlet is fluidly connected with the concentrate water outlet. In some embodiments, the permeate water outlet and concentrate water outlet are circular. In some embodiments, the concentrate water outlet is located on the outside of the permeate water outlet. In some embodiments, the permeate water inlet comprises multiple permeate water inlets and the concentrate water inlet is a single concentrate water inlet. In some embodiments, the multiple permeate water inlets surround the single concentrate water inlet. In some embodiments, the rear side of the main body has a permeate water connection column and a concentrate water connection column extending along a central axis of the end cap and having flow channels inside. In some embodiments, each permeate water tube forms a first flow channel through the interior of the permeate water tube, wherein the central channel forms a second flow channel, and wherein the membrane assembly has an outer surface forming a third flow channel. In some embodiments, the first flow channel is connected with the permeate water inlet and the second flow channel is connected with the concentrate water inlet.

In some embodiments, the water purification cartridge comprises a second pair of permeate water tubes. In some embodiments, the membrane assembly comprises at least two first membrane structures, each of the first membrane structures wrapped around a respective first permeate water tube of each of the first and second pairs of permeate water tubes, and at least two second membrane structures, each of the second membrane structures wrapped around a respective second permeate water tube of each of the first and second pairs of permeate water tubes. In some embodiments, the permeate water tubes have a non-circular cross-sectional shape. In some embodiments, the non-circular cross-sectional shape is generally a tear-drop shape. In some embodiments, each permeate water tube has an outer wall, a front wall, an inner wall, and a back wall, wherein the outer wall and front wall taper toward one another to form a pointed transition and gradually open away from one another to meet with the back wall and inner wall, respectively, wherein the back wall is gradually rounded, and wherein the distance between the outer wall and the inner wall gradually increases from the backwall until a midpoint and then decreases at a greater rate until the inner wall transitions to the front wall. In some embodiments, the front wall has a contour corresponding to that of the back wall such that for two adjacent permeate water tubes the front wall of a first of the two adjacent permeate water tubes smoothly transitions to the back wall of a second of the two adjacent permeate water tubes.

In some embodiments, the central core is cylindrical.

Some embodiments provide a water purification cartridge comprising a central core comprising at least a first pair of permeate water tubes; and a membrane assembly wrapped around and covering the central core, wherein each of the permeate water tubes has a generally tear-drop shaped cross-section.

In some embodiments, the water purification cartridge comprises a second pair of permeate water tubes, each of the permeate water tubes having the same generally tear-drop shape as the water permeate tubes of the first pair of water permeate tubes. In some embodiments, each permeate water tube has an outer wall, a front wall, an inner wall, and a back wall, wherein the outer wall and front wall taper toward one another to form a pointed transition and gradually open away from one another to meet with the back wall and inner wall, respectively, wherein the back wall is gradually rounded, and wherein the distance between the outer wall and the inner wall gradually increases from the backwall until a midpoint and then decreases at a greater rate until the inner wall transitions to the front wall. In some embodiments, the front wall has a contour corresponding to that of the back wall such that for two adjacent permeate water tubes the front wall of a first of the two adjacent permeate water tubes smoothly transitions to the back wall of a second of the two adjacent permeate water tubes.

In some embodiments, the membrane assembly comprises at least a first membrane structure wrapped around a first permeate water tube of the first pair of permeate water tubes, thereby creating a first permeate water tube assembly, and a second membrane structure wrapped around a second permeate water tube of the first pair of permeate water tubes, thereby creating a second permeate water tube assembly, and wherein the first and second membrane structures are different.

### BRIEF DESCRIPTION OF THE DRAWINGS

FIG. 1 is a schematic diagram of a water purification cartridge in accordance with embodiments of the present disclosure;

FIG. 2 is a cross-sectional view of FIG. 1 along line 2-2;

FIG. 3 is a cross-sectional view of FIG. 1 along line 3-3;

FIG. 4 is a cross-sectional view of FIG. 3 in a first configuration depicting a condition before membrane assemblies are wound into the water purification cartridge;

FIG. 5 is an enlarged side partial cross sectional view of a first permeate water tube assembly as shown in FIG. 4;

FIG. 5A is a cross-sectional view of a permeate water tube;

FIG. 5B is a cross-sectional view of another permeate water tube;

FIG. 6 is an enlarged side partial cross sectional view of a second permeate water tube assembly as shown in FIG. 4;

FIG. 7 is an isometric schematic view of a permeate water tube for use in a permeate water tube assembly as shown in FIGS. 4-6;

FIG. 8 is an isometric schematic view of a second embodiment of a permeate water tube in accordance with embodiments of the present disclosure;

FIG. 9 is a further schematic diagram of the permeate water tube of FIG. 8;

FIG. 10 is a cross-sectional view of FIG. 9 taken along 10-10;

FIG. 11 is a schematic view of a third embodiment of a permeate water tube in accordance with embodiments of the present disclosure;

FIG. 12 is a further schematic diagram of the permeate water tube of FIG. 11;

FIG. 13 is a cross-sectional view of FIG. 12 taken along the line 13-13;

FIG. 14 is a schematic drawing of a secondary central tube of a water purification cartridge;

FIG. 15 is a cross-sectional view similar to FIG. 2, but wherein the cartridge includes six permeate water tubes;

FIG. 16 is a front isometric view of a first end cap, in accordance with embodiments of the present disclosure;

FIG. 17 is a rear isometric view of the first end cap of FIG. 16;

FIG. 18 is a front elevational view of the first end cap of FIG. 16;

FIG. 19 is a cross-sectional view taken along line 19-19 of FIG. 18;

FIG. 20 is a cross-sectional view taken along line 20-20 of FIG. 18;

FIG. 21 is a schematic isometric view of a second end cap of a water purification cartridge;

FIG. 22 is a graph showing permeate flow versus water recovery;

FIG. 23 is a graph showing permeate flow versus feed water pressure;

FIG. 24 is a graph showing total dissolved solids rejection versus water recovery;

FIG. 25 is a graph showing total dissolved solids rejection versus feed water pressure;

FIG. 26 is a graph showing the percentage of initial permeate flow versus water production capacity; and

FIG. 27 is a graph showing total dissolved solids rejection versus water production capacity.

### DEFINITIONS

Unless stated to the contrary, implicit from the context, or customary in the art, all parts and percents are based on weight. For purposes of United States patent practice, the contents of any referenced patent, patent application or publication are incorporated by reference in their entirety (or its equivalent US version is so incorporated by reference) especially with respect to the disclosure of definitions (to the extent not inconsistent with any definitions specifically provided in this disclosure) and general knowledge in the art.

The numerical ranges disclosed herein include all values from, and including, the lower value and the upper value. For ranges containing explicit values (e.g., a range from 1, or 2, or 3 to 5, or 6, or 7) any subrange between any two explicit values is included (e.g., the range 1-7 above includes all subranges 1 to 2; 2 to 6; 5 to 7; 3 to 7; 5 to 6; etc.).

The terms “comprising,” “including,” “having” and like terms are not intended to exclude the presence of any additional component, step or procedure, whether or not the same is specifically disclosed. All processes claimed through use of “comprising” may include one or more additional steps, pieces of equipment or component parts, and/or materials unless stated to the contrary. In contrast, the term, “consisting essentially of” excludes from the scope of any succeeding recitation of any other component, step or procedure, excepting those that are not essential to operability. The term “consisting of” excludes any component, step or procedure not specifically delineated or listed. The term “or,” unless stated otherwise, refers to the listed members individually as well as in any combination.

“Direct contact” is a configuration whereby two components are in physical contact with each other with no intervening layer(s) and/or no intervening material(s) located between a portion of the two contacting components. Similarly, it shall be noted that unless otherwise specified or determined, terms such as “installation,” “joint,” “connection” and like terms should be understood generally. For example, a “fixed connection,” “detachable connection” or “integrated connection” may be a mechanical connection, fluid connection (connection by which the passage of fluid is permitted) or an electrical connection. Such a connection may be a direct connection or an indirect connection through intermediate materials or structures.

Orientation or positional relationships, such as indicated by “center,” “up,” “down,” “left,” “right,” “vertical,” “horizontal,” “inner,” “outer” and like terms are with reference to the drawings and are only used to describe the drawings and simplify the description. Such terms do not indicate or imply the structures or devices described must have a specific orientation or be constructed or operated in a specific orientation. In addition, such terms as “primary,” “secondary,” “thirdly” and the like are only used for the description and do not indicate or imply any importance of dominance.

### DETAILED DESCRIPTION

The present disclosure provides a water purification cartridge. The water purification cartridge includes a plurality of permeate water tubes disposed about a central channel. The central channel optionally include a secondary central tube.

FIG. 1 shows a water purification cartridge 100 with a first end cap 70 and a second end cap 90 provided at respective ends of the water purification cartridge 100. A membrane assembly 10 is wrapped around the internal components of the water purification cartridge 100 and is disposed between the first end cap 70 and the second end cap 90.

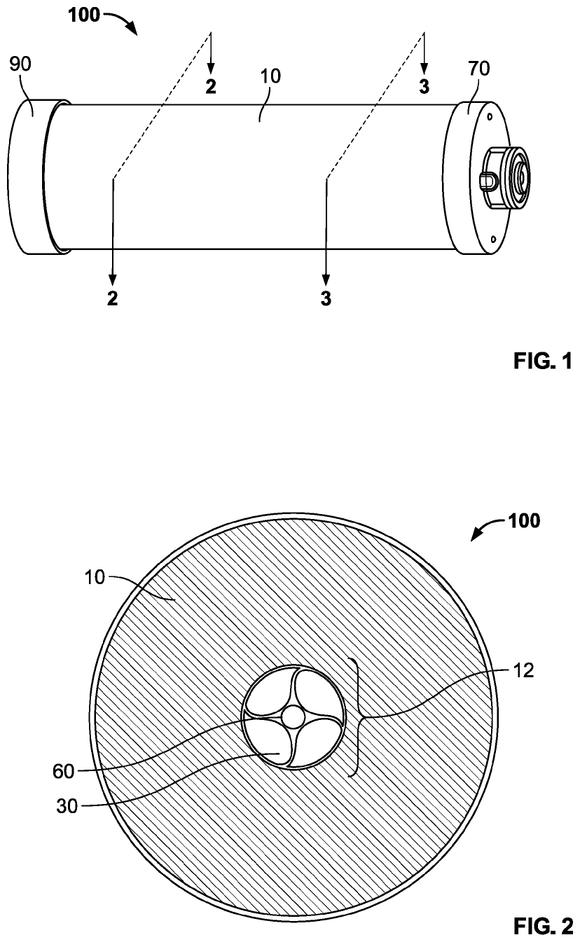

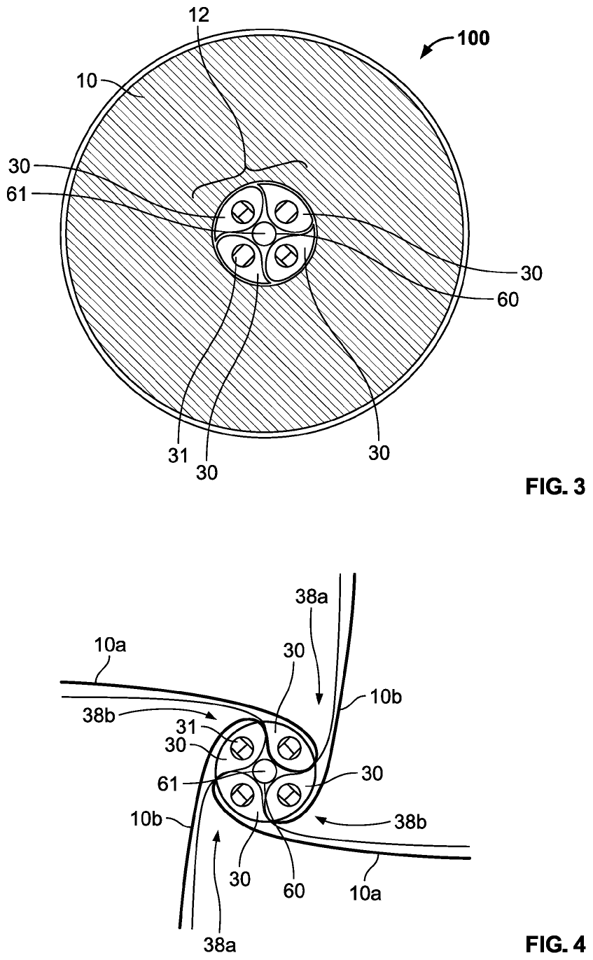

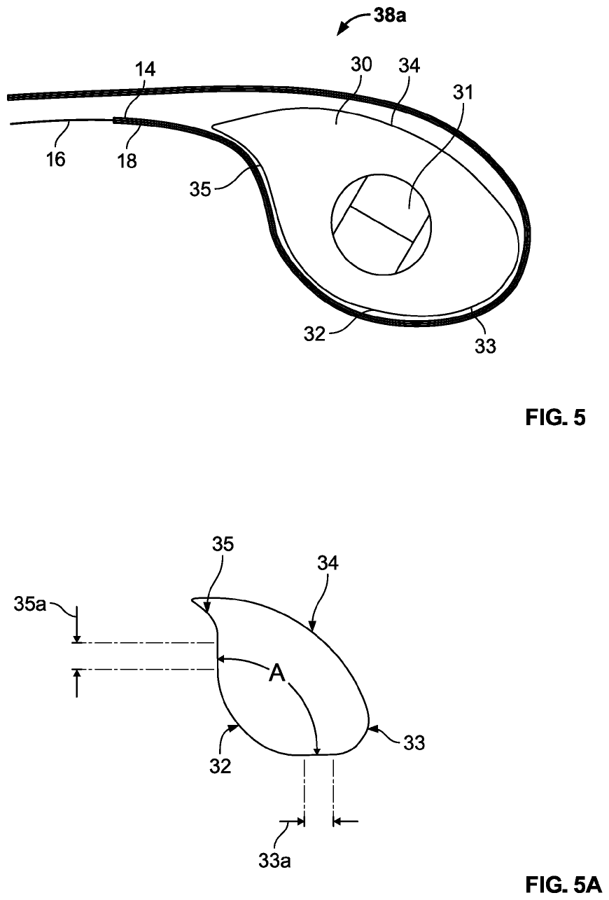

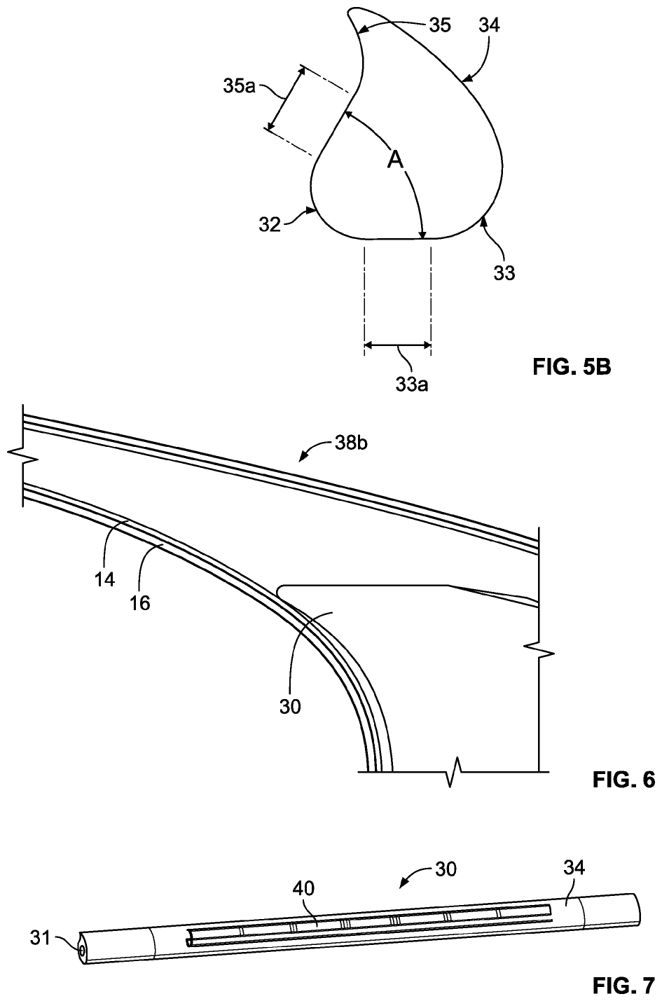

With reference to FIGS. 2 and 3, the membrane assembly 10, composed of multiple individual membranes, is wrapped around a central core 12 of the cartridge 100. In the embodiment shown, the central core 12 includes a plurality of permeate water tubes 30 disposed around a secondary central tube 60, the secondary central tube positioned in the central channel formed by the permeate water tubes 30. Each of the permeate water tubes 30 has an inside channel which forms a first flow channel 31, while the inside channel of the secondary central tube 60 forms a second flow channel 61. In the embodiments shown, the water permeate tubes 30 are each wrapped in one of the membranes of the membrane assembly 10 to form permeate water tube assemblies 38, as shown in further detail in FIGS. 5 and 6. As such, the membrane assembly 10 is composed of a plurality of membranes, wherein the plurality of membranes is equal to the number of permeate water tubes 30.

In the embodiments described herein, there are two different membrane structures or configurations, for example, 10a and 10b, as shown in FIG. 4. Moreover, the permeate water tube assemblies 38 are provided in pairs such that there is always an even number of water permeate tubes 30, with each permeate water tube 30 of a given pair wrapped with a different membrane configuration. As a result, each permeate water tube pair is composed of one permeate water tube assembly 38a (wrapped in membrane 10a) and permeate water tube assembly 38b (wrapped in membrane 10b). The pairs of permeate water tubes are arranged such that the permeate water tube assemblies 38 are in an A-B-A-B pattern about the central core 12. That is, the permeate water tube assemblies 30 are arranged in a 38a-38b-38a-38b pattern.

Turning to FIGS. 5 and 6, the membrane assembly 10 is composed of a number of a plurality of individual membranes, the exact number corresponding to the number of permeate water tubes 30. In an embodiment, each individual membrane of the membrane assemblyl0 includes at least one of a first functional layer 14, a filtering layer 16, and a second functional layer 18. A functional layer performs a function other than filtering. The first functional layer 14 and the second functional layer 18 can be the same or different. Further, the first functional layer 14, filtering layer 16, and/or second functional layer 18 can be one or more sublayers.

In an embodiment, the first functional layer 14 is a permeate water carrier layer. A permeate water carrier layer has a thickness from 4 mils, or 6 mils, or 8 mils, or 10 mils, or 12 mils to 14 mils, or 16 mils, or 18 mils, or 20 mils, or 25 mils. Preferably, the permeate water carrier layer has a thickness from 8 mils, or 10 mils to 12 mils, or 14 mils, or 21 mils. In an embodiment, a permeate water carrier layer is made of a polyester material (e.g., polyethylene terephthalate or polybutylene terephthalate), polytetrafluoroethylene, epoxy-impregnated polyesters, epoxy-impregnated polytetrafluoroethylene, polypropylenes, polyethylenes, and combinations thereof.

In an embodiment, the second functional layer 18 is a spacer layer. A spacer layer has a thickness from 5 mils, or 10 mils, or 15 mils to 20 mils, or 25 mils, or 29 mils, or 35 mils, or 40 mils, or 50 mils, or 75 mils, or 100 mils, or 125 mils, or 150 mils. Preferably, the spacer layer has a thickness from 10 mils, or 15 mils, or 17 mils, or 20 mils to 25 mils, or 29 mils, or 31 mils, or 34 mils. A spacer layer may be any suitable material as long as it provides sufficient flow and separation between adjacent membrane layers. In a particular embodiment, the spacer layer is made of any suitable polymeric material, including, but not limited to, polypropylenes, polyethylenes (e.g., low density polyethylene), polyamides, polybutylene terephthalate, polytetrafluoroethylene, polyurethane, polymeric adhesive resins, and combinations thereof.

Spacer layers may be a standalone layer or formed directly on a filtering layer of a membrane. In an embodiment, the spacer layer is a standalone layer, such as a layer of mesh material, plastic netting, or a 3D printed layer. In other embodiments, the spacer layer is formed directly on a membrane surface by chemical reaction or 3D printing. In embodiments in which the spacer layer is 3D printed, the spacer layer has a thickness from 5 mils, or 10 mils, or 15 mils, or 20 mils to 25 mils, or 30 mils, or 35 mils, or 40 mils, or 45 mils, or 50 mils. Preferably, a 3D printed spacer layer has a thickness from 5 mils, or 10 mils to 15 mils, or 17 mils, or 20 mils, or 25 mils, or 32 mils, or 34 mils. Suitable materials for a 3D printed spacer layer include, but are not limited to, polypropylenes, polyethylenes, polyurethanes, polymeric adhesive resins, and combinations thereof.

In an embodiment, the filtering layer 16 includes a substrate layer and a separation layer deposited on the substrate layer or cast on a surface of the substrate layer as a functional coating. In an embodiment, the filtering layer 16 is a separation membrane with permselectivity, and the filtering layer 16 can be one of the reverse osmosis membrane, nanofiltration membrane, ultrafiltration membrane, and combinations thereof. In an embodiment, the filtering layer 16 has a thickness from 0.25 mils, or 0.5 mils, or 1 mil, or 1.5 mils, or 2 mils, or 2.5 mils, or 4 mils, or 6 mils, or 10 mils to 15 mils, or 20 mils, or 25 mils, or 30 mils, or 35 mils, or 40 mils. In an embodiment, the filtering layer 16 is a reverse osmosis membrane. A filtering layer, which is a reverse osmosis membrane, preferably has a thickness from 0.25 mils, or 0.5 mils, or 1 mil, or 1.5 mils, or 2 mils, or 2.5 mils, or 4 mils, or 4.5 mils, or 5 mils, or 5.5 mils, or 6 mils, or 10 mils to 15 mils, or 20 mils, or 25 mils, or 30 mils, or 35 mils, or 40 mils. Exemplary materials suitable for use in a reverse osmosis membrane as a filtering layer include thin film composite polyamides, cellulose acetate, polyimides, polyesters, nanomaterials such as graphene oxide, zeolite, silica, titanium dioxide, carbon nanotubes incorporated thin film nanocomposites, biomimetic desalination membranes such as aquaporin and synthetically designed nanochannels incorporated thin film composites, zwitterionic polymers, polyethylenes, polypropylenes and combinations thereof.

In an embodiment, the filtering layer 16 is a nanofiltration membrane. A filtering layer which is a nanofiltration membrane preferably has a thickness from 0.25 mils, or 0.5 mils, or 1 mil, or 1.5 mils, or 2 mils, or 2.5 mils, or 4 mils, or 4.5 mils, or 5 mils, or 5.5 mils, or 6 mils, or 10 mils to 15 mils, or 20 mils, or 25 mils, or 30 mils, or 35 mils, or 40 mils. Exemplary materials suitable for use in a nanofiltration membrane as a filtering layer include polyamides, cellulose acetate, polyimides, polyesters, nanomaterials such as graphene oxide, zeolite, silica, titanium dioxide, carbon nanotubes incorporated thin film nanocomposites, biomimetic desalination membranes such as aquaporin and synthetically designed nanochannels incorporated thin film composites, zwitterionic polymers, polyethylenes, polypropylenes, pore-filling and/or layer-by-layer coated polysulfone and polyethersulfone ultrafiltration membranes, and combinations thereof

In an embodiment, the filtering layer 16 is an ultrafiltration membrane. A filtering layer which is an ultrafiltration membrane preferably has a thickness from 5 mils, or 10 mils, or 15 mils to 20 mils, or 25 mils, or 30 mils. Exemplary materials suitable for use in an ultrafiltration membrane as a filtering layer include polypropylenes, polystyrene, polysulfone, polyethersulfone, polyvinylidene fluoride, polytetrafluoroethylene, sintered polymeric membranes, block-copolymer membranes, and combinations thereof.

In an embodiment, a first membrane 10a and a second membrane 10b have a thickness (independently) of 4 mils, or 5 mils, or 10 mils, or 25 mils, or 50 mils, or 75 mils, or 100 mils to 125 mils, or 150 mils, or 175 mils, or 200 mils, or 225 mils. Preferably the membranes 10a and 10b have a thickness (independently) of 4 mils, 5 mils, 10 mils, or 15 mils, or 20 mils to 25 mils, or 30 mils, or 35 mils, or 40 mils.

In the embodiment shown in FIG. 4, the membrane assembly 10 includes two first membranes 10a and two second membranes 10b. A first membrane 10a in association with a permeate water tube forms permeate water tube assemblies 38a, and a second membrane 10b in association with a permeate water tube forms permeate water tube assemblies 38b. That is, the first membrane 10a and second membrane 10b are different. In the particular embodiment shown, the first membrane 10a and second membrane 10b are different and can be a reverse osmosis membrane and a nanofiltration membrane, respectively.

In particular, in the embodiments shown in FIGS. 4-6, the first membrane 10a comprises, or consists essentially of, or consists of the first functional layer 14, filtering layer 16, and the second functional layer 18. These layers can be directly adjacent or include one or more intervening layers, such as adhesive layers or other layers which do not change the functionality of the first functional layer 14, filtering layer 16 and second functional layer 18. In the embodiment shown, the first membrane 10a consists essentially of, or consists of, a first functional layer 14, a filtering layer 16, and a second functional layer 18, wherein each of the layers 14, 16, 18 have a first planar surface and a second planar surface, and wherein the second planar surface of the first functional layer 14 is in direct contact with the first planar surface of the filtering layer 16, and the second planar surface of the filtering layer 16 is in direct contact with the first planar surface of the second functional layer 18, as shown in FIG. 5. Similarly, in the embodiment shown, the second membrane 10b comprises, or consists essentially of, or consists of the first functional layer 14 and the filtering layer 16. These layers can be directly adjacent or include one or more intervening layers, such as adhesive layers or other layers which do not change the functionality of the first functional layer 14 and the filtering layer 16. In the embodiment shown, the second membrane 10b consists essentially of, or consists of, a first functional layer 14, and a filtering layer 16, wherein each of the layers 14, 16 have a first planar surface and a second planar surface, and wherein the second planar surface of the first functional layer 14 is in direct contact with the first planar surface of the filtering layer 16, as shown in FIG. 6.

Returning to FIG. 4, showing two pairs of permeate water tubes in the central core 12, a first membrane 10a is wrapped around a first of the permeate water tubes 30 in a given pair to form permeate water tube assembly 38a, and a second membrane 10b is wrapped around a second of the permeate water tubes 30 in a given pair to form permeate water tube assembly 38b. When the first and second membranes 10a, 10b include a first functional layer 14 as one of its layers, the first and second membranes 10a, 10b are wrapped around their respective permeate water tubes 30 with the first functional layer 14 against the permeate water tube 30. In such embodiments, the first functional layer 14 may be considered the inner layer. The outer layer then is either the second functional layer 18 (with a filtering layer 16 sandwiched in between as shown in permeate water tube assembly 38a ) or a filtering layer 16 alone (as in permeate water tube assembly 38b ).

When permeate water tube assemblies 38a, 38b are positioned adjacent one another as shown in FIG. 4, for example, a portion of the first membrane 10a is in contact either directly or indirectly, preferably directly, with a portion of the second membrane 10b. In the present embodiment, a portion of the outer layer of the first membrane 10a is in contact with a portion of the outer layer of the second membrane 10b. That is, in the embodiment shown in FIGS. 4-6, a portion of the second functional layer 18 of the first membrane 10a of permeate water tube assembly 38a is in contact with a portion of the filtering layer 16 of the second membrane 10b of permeate water tube assembly 38b.

FIGS. 7-13 illustrate exemplary permeate water tubes 30 for use in the cartridge 100.

The permeate water tubes 30 used in the embodiments shown in FIGS. 1-6 are permeate water tubes 30 as shown in FIG. 7. The permeate water tube 30, which is used in both the permeate water tube assembly 38a and the permeate water tube assembly 38b, includes an outer wall 34, a front wall 35, a back wall 33 and an inner wall 32. As shown in FIG. 4, the outer wall 34 forms a portion of the outer wall of the central core 12, and the inner wall 32 forms a portion of the inner wall of the central core 12 to form the opening in which the secondary central tube 60 is positioned.

As shown in FIGS. 5 and 7, an exemplary permeate water tube 30 has cross-sectional shape similar to a tear-drop. The permeate water tube 30 has an outer wall 34 and a front wall 35 that taper toward one another to form a pointed transition and gradually open away from one another to meet with the inner wall 32 and back wall 33 to form a rounded portion. More specifically, the back wall 33 is gradually rounded, and the distance between the outer wall 34 and the inner wall 32 gradually increases from the back wall 33 until a midpoint and then decreases at a greater rate until the inner wall 32 transitions to the front wall 35. Further, in the embodiment shown, the front wall 35 has a contour corresponding to that of the back wall 33, such that for two adjacent permeate water tubes 30, the front wall 35 of the first smoothly transitions to the back wall 33 of the second to create the round or roughly cylindrical shape of the central core 12.

In some embodiments, particularly when the cross-sectional profile of the permeate water tube is a non-circular tear-shape, the specific shape, dimensions and angles of the walls varies depending on the number of permeate water tubes used in the cartridge 100. The angle A between the front wall 35 and the back wall 33 is determined by dividing 360° by the total number of permeate water tubes 30 used. For a four-leaf design, the angle A is 90°. For a six-leaf design, the angle A is 60°. For an eight-leaf design, the angle A is 45°. The radius of the outer wall 34 is the same as, or up to 5% smaller than, the radius of the central core 12. The radius of the front wall 35 is 20% to 150% larger than that of the back wall 33. The radius of the inner wall 32 can be given as any values to guarantee enough space is left for placing all of the permeate water tubes 30 and the secondary central tube 60 to form the central core 12 and allow membrane rolling around it.

FIGS. 5A and 5B illustrate the non-circular, tear-shaped cross-sectional profile in further detail. Specifically, FIG. 5A shows the cross-sectional profile of a permeate water tube 30a when four permeate water tubes are used, and FIG. 5B shows the cross-sectional profile of a permeate water tube 30b when six permeate water tubes are used. In the particular embodiments shown, the front wall 35 and the back wall 33 both have linear portions 35a and 33a, respectively. The angle between the front wall 35 and back wall 33 is measured as the angle between these linear portions 35a and 33a. It will be appreciated that the difference in angle between the embodiments of FIG. 5A and FIG. 5B results in the differences in the radii of the walls and ultimate specific dimensions of the tear-shape which are required in order to complete the ring about the central core 12.

The outer wall 34 of the permeate water tube 30 includes a guide groove 40. The guide groove 40 is in fluid connection with the first flow channel 31 and sits along the direction of water flow. While only a single guide groove 40 is depicted, in further embodiments, any number of guide grooves of varying dimensions may be provided on the outer wall of the permeate water tube.

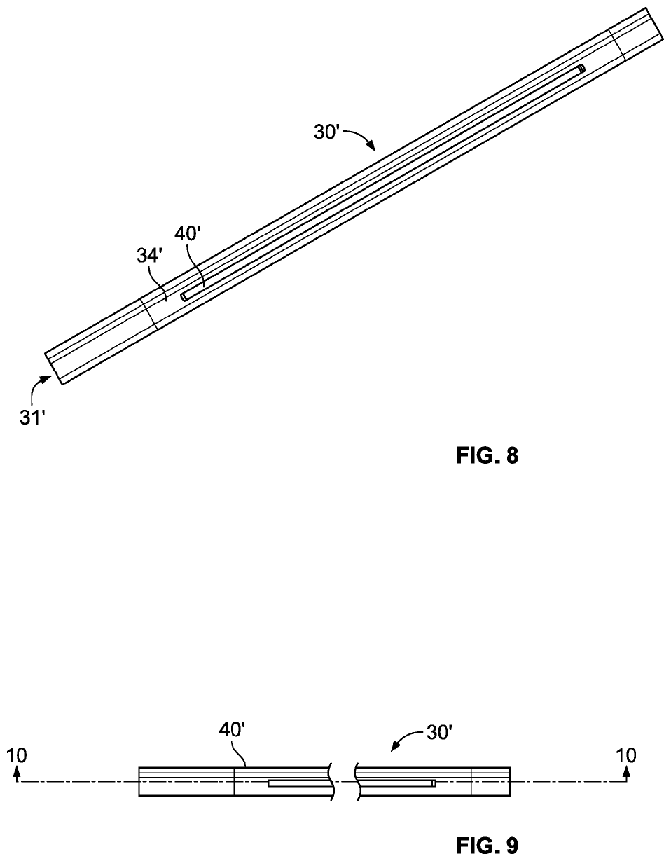

FIGS. 8-10 illustrate a further embodiment of a permeate water tube 30′ also having a single guide groove 40′ on the outer wall 34′. The guide grove 40′ fluidly connects with the first flow channel 31′ through the opening hole 46′. In the embodiment shown in FIG. 15, rather than having a tear drop-shaped cross-sectional profile as the permeate water tube 30, the permeate water tube 30′ has a generally triangular cross-sectional profile, with the points of the triangle being rounded.

FIGS. 11-13 illustrate yet a further embodiment of a permeate water tube 30″, in which the entire structure is tubular with a substantially circular cross-sectional profile and the sealing portions 42″ are sealing rings. While in the embodiments shown, sealing portions 42″ are described as various structural components or sealing rings, it will be appreciated that other sealing structures and components may be used, such as, for example, a sealant compound, ultrasonic seal, mechanical connection (e.g., corresponding contoured structures, male/female structures, click lock structures, etc.), and combinations of these and other sealing structures.

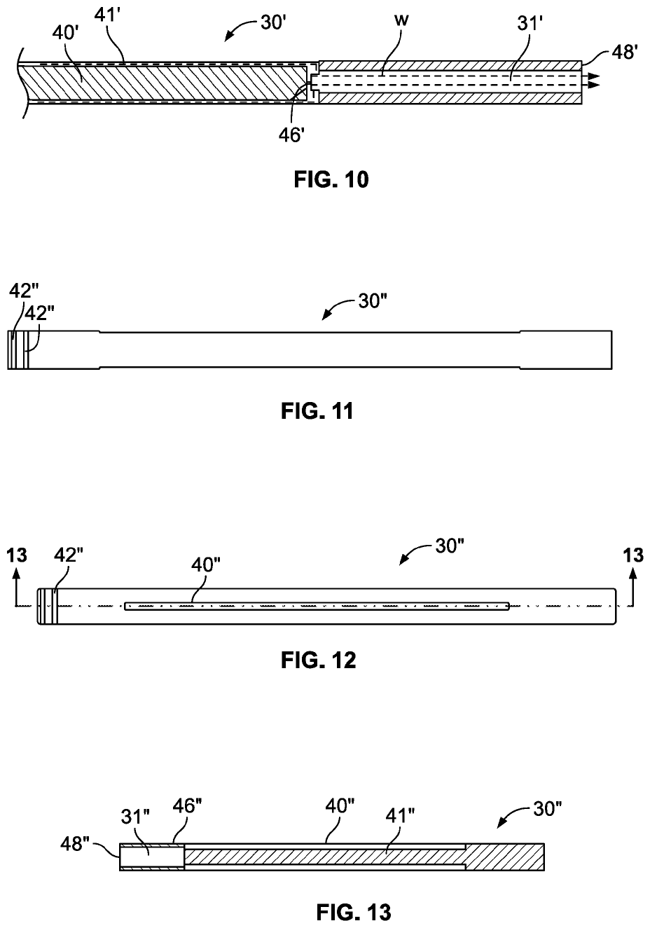

With particular reference to FIGS. 9 and 10, the internal structure of an exemplary permeate water tube 30′ is described. It will be appreciated that while the internal structure of the permeate water tube is described with reference to permeate water tube 30′, it will be appreciated that the same or equivalent internal structures may be provided with respect to the permeate water tube 30 and the permeate water tube 30″ (as illustrated in FIGS. 12-13).

The guide groove 40′ includes a groove opening 41′ such that the guide groove 40′ is fluidly connected with the first flow channel 31′, which in the embodiment shown is the permeate water inlet and outlet. The first flow channel 31′ has an opening 46′ and an outlet 48′. As source water is filtered by the cartridge 100, it passes through the membrane assembly 10 and the filtered product water, that is, the permeate water, enters the first flow channel 31′ and is carried out of the cartridge 100 for use. The water pathway through the permeate water tube is marked as W.

The end part of the guide groove 40′ is connected with the other end of the first flow channel 31′. The guide groove 40′ extends along the length of the permeate water tube 30′ so that the water can flow from the left to the right (with respect to the orientation shown in FIGS. 9-10), forming water diversion. While in the embodiment shown, the permeate water tube 30′ has a single guide groove 40′, in other embodiments, there may be multiple grooves provided, with the multiple grooves arranged symmetrically or asymmetrically. Further, multiple grooves may be isolated from one another or may be mutually connected to form a groove network.

In the embodiment shown in FIG. 13, the length of the groove opening 41″ is greater than that of the opening 46″ of the permeate water channel 31″. Since the groove opening 4″ is solid, the length of an injection mold pull used to manufacture the permeate water tube 30″ only needs to meet the length of the opening 46″ of the permeate water channel 31″, which greatly reduces the length of the loose core used in the injection mold pull process, thus making the molding easier to lower process energy and save cost.

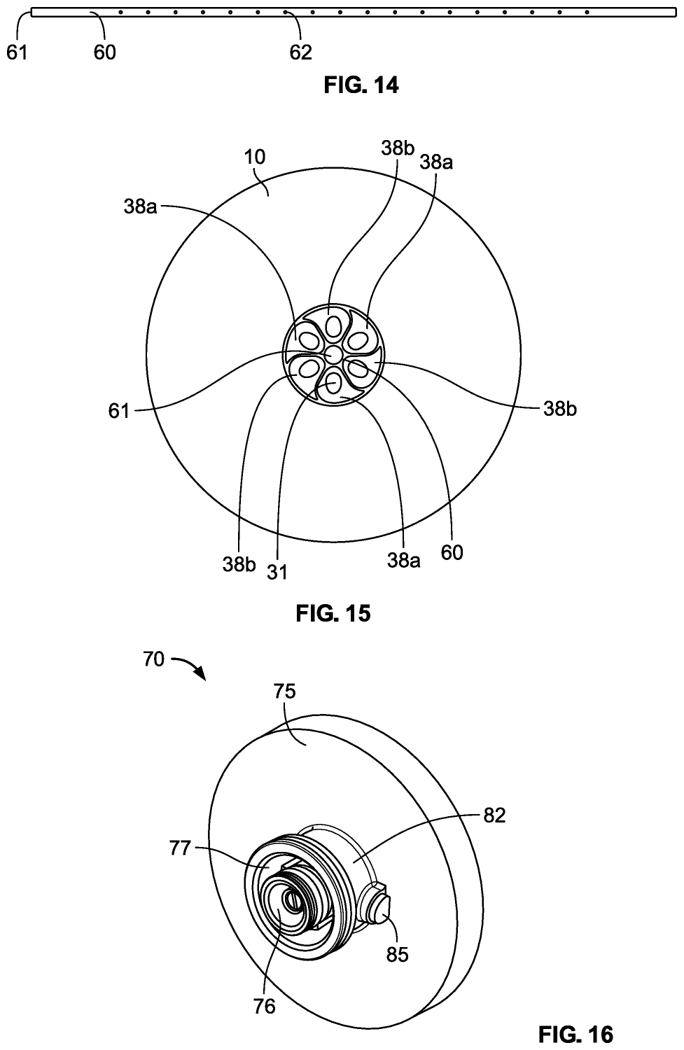

FIG. 14 illustrates an exemplary secondary central tube 60 with a second flow channel 61. The body of the secondary central tube 60 includes a plurality of through holes 62 to fluidly connect the secondary central tube 60 with the inner cavity of the central core 12 formed by the arrangement of the permeate water tube assemblies 38a, 38b. In the reverse osmosis membrane rolling process, it is beneficial to use a central tube, such as the secondary central tube 60, to support the structure. In accordance with some embodiments the secondary central tube 60 is injection molded.

In further embodiments, a secondary central tube 60 may be omitted, with the flow channel which would be provided by the secondary central tube formed by the natural channel occurring in the center of the assembled permeate water tube assemblies. The secondary central tube 60 is helpful, however, in the rolling of the membrane to provide additional structural and mechanical support. In some embodiments, a secondary central tube 60 is used only during rolling of the membrane and then slid out prior to assembling the end caps on the cartridge 100. When a secondary central tube is used only for support during manufacture, such secondary central tube may be a simple rod or other elongated structure.

While in the embodiments shown thus far, the cartridge 100 is shown with two pairs of permeate water tube assemblies, that is, two permeate water tube assemblies 38a and two permeate water tube assemblies 38b, with each pair made of one permeate water tube assembly 38a and one permeate water tube assembly 38b, resulting in a pattern of 38a-38b-38a-38b about the secondary central tube 60, in further embodiments, there may be more than two pairs of permeate water tube assemblies. For example, in some embodiments, and as shown in FIG. 15, there may be three pairs of permeate water tube assemblies. In still further embodiments, there may be two, three, four, or even more than four pairs of permeate water tube assemblies, provided. In some embodiments, the permeate water tube assemblies will only be provided in pairs. That is, in an embodiment, the membrane assembly 10 consists essentially of, or consists of, two and only two different membranes, with the permeate water tube assemblies provided in pairs with one of each pair having a respective one of the membranes and the other of each pair having the other of the membranes.

In further embodiments, the membrane assembly 10 may be composed of more than two different membranes, provided, however, that in embodiments in which a first pair of membranes is composed of 10a and 10b, any further membranes provided are functionally equivalent (i.e., same structure, different materials) to membranes 10a and/or 10b (e.g., further membranes being 10a ′ and/or lob') and are used in place of the respective one of 10a and/or 10b in a permeate water tube assembly 38. In other words, additional membranes are acceptable provided the additional membranes do not change the overall permeate water tube assembly pattern of 38a-38b-38a-38b, with “a” and “b” being general denotations of the structure of a membrane more so than the materials of the specific structural layers.

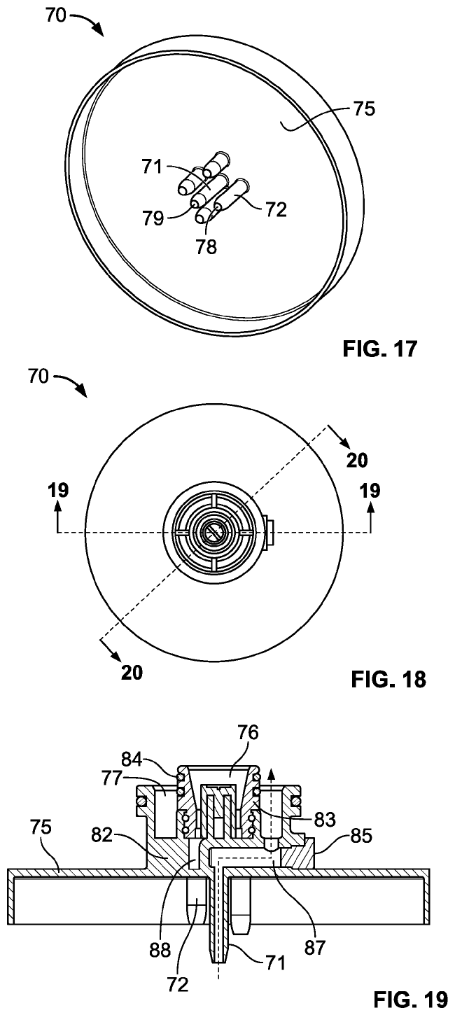

FIGS. 16-21 depict the first end cap 70 and second end cap 90 in detail. The first end cap 70 has a main body 75, and the front side of the main body 75 has a permeate water outlet 76 and a concentrate water outlet 77, while the rear side is provided with a permeate water inlet 78 and a concentrate water inlet 79. The concentrate water inlet 79 is fluidly connected with the concentrate water outlet 77. Also shown on the front side of the first end cap 70 is a water outlet 82 protruding along its axis, and the permeate water outlet 76 and concentrate water outlet 77 are formed on the water outlet 82. A permeate water connector 83 is provided at the permeate water outlet 76 on the water outlet 82, and a seal 84 is arranged between the permeate water outlet 76.

Both the permeate water outlet 76 and the concentrate water outlet 77 are circular in the embodiment shown, and the concentrate water outlet 77 is located on the outside of the permeate water outlet 76. In other embodiments, the concentrate water outlet 77 may have a shape other than circular, such as, for example, polygonal. In still further embodiments, the specific arrangement of the concentrate water outlet 77 and permeate water outlet 76 may vary, provided the components remain functional.

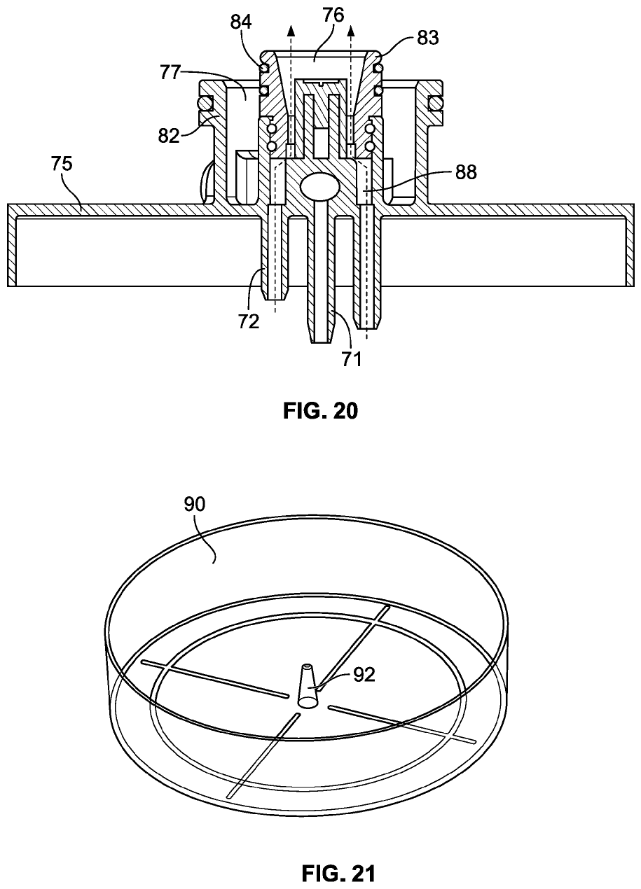

In the embodiment shown, the first end cap 70 includes multiple permeate water inlets 78 and a single concentrate water inlet 79, with the permeate water inlets 78 surrounding the single concentrate water inlet 79. Specifically, with further references to FIGS. 19 and 20, the rear side of the end cap 70 has a permeate water connection column 72 and a concentrate water connection column 71 which extend along the end cap's 70 central axis and have flow channels inside. That is, the concentrate water connection column 71 contains a second flow inlet and outlet and the permeate water connection column 72 contains a first flow inlet and outlet. The permeate water inlet 78 is arranged at the end of the permeate water connection column 72, and the concentrate water inlet 79 is arranged at the end of the concentrate water connection column 71.

Because the concentrate water outlet 77 is located on the outside of the permeate water outlet 76, and the permeate water inlet 78 is located on the outside of the concentrate water inlet 79, a reverse or inverted waterway is formed between the inlet and the outlet. The concentrate water inlet 79 and the concentrate water outlet 77 are connected through the concentrate water connection channel 87. The concentrate water connection channel 87 extends radially along the water outlet part 82 on the end cap body 75, that is, from the inside out, as shown in FIG. 19. When the concentrate water connection channel 87 is opened in the water outlet section 82, the concentrate water connection channel 87 needs to be connected with the outside to form a connection port, so the connection port is shown blocked by plug 85.

The permeate water inlet 78 and permeate water outlet 76 are connected through permeate water connection channel 88, and the permeate water connection channel 88 extends along the axial direction of the water outlet part 82 on the end cap body 75, as shown in FIG. 20. In other words, the distribution position of multiple permeate water inlets 78 and the position of permeate water outlet 76 are arranged on both sides of the end cap body 75 correspondingly.

As previously described, the outer wall of the permeate water tube 30 is provided with the guide groove 40 (not shown in FIGS. 16-20). The inside of each permeate water tube 30 forms the first flow channel 31, which is connected with the permeate water inlet 78 on the first end cap 70. The inside of the secondary central tube 60 has the through hole forming the second flow channel 61 which is connected with the concentrate water inlet 79 of the first end cap 70.

The outer surface of the membrane assembly 10 forms the third flow channel of the cartridge 100. The second end cap 90 (shown in further detail in FIG. 21) closes the other end of the cartridge 100 by inserting the connector 92 into the secondary central tube 60.

In an embodiment, the first flow channel 31 is for permeate water, the second flow channel 61 is for waste water, and the third flow channel is for feed water. In such an embodiment, the first functional layer 14 is the permeate water carrier and the second functional layer 18 is the inlet mesh spacer layer. The outer surface of the membrane assembly 10 of the filter cartridge 100 faces the inlet mesh layer 18, and the separation layer of the filtering layer 16 faces the second functional layer 18. The feed water enters the membrane assembly 10 through the third water inlet and outlet on the side. Under the guidance of the permeate water carrier 14, the purified/permeate water filtered through the filtering layer 16 enters the first flow channel 31 inside of the permeate water tube 30 through the guide groove 40. The waste/concentrate water on the other side of the filtering layer 16 enters the second flow channel 61 in the secondary central tube 60.

In another embodiment, the flow channel 31 is for waste/concentrate water, the second flow channel 61 is for permeate water, and the third inlet and outlet is for feed water. In this particular embodiment, the functional coating of the filtering layer 16 is oriented towards the functional layer 14. The feed water enters the membrane assembly 10 through the third water inlet and outlet on the side. Under the guidance of the functional layer 14, the waste water not filtered by the filtering layer 16 enters the first flow channel 31 inside of the permeate water tube 30 through the guide groove 40 on the outer wall of the permeate water tube 30 and then is discharged through the first flow channel 31. The permeate water on the other side of the filtering layer 16 enters the second flow channel 61 in the secondary central tube 60 and is discharged through the second flow channel 61.

In a further embodiment, the first flow channel 31 is for feed water, the second flow channel 61 is for permeate water, and the third flow channel is for waste water. In such an embodiment, the first functional layer 14 is the feed spacer layer, and the second functional layer 18 is the permeate water carrier. The outer surface of the membrane assembly 10 of the water purification cartridge 100 faces the permeate water carrier 18, and the functional coating of the filtering layer 16 is facing the first functional layer 14. The permeate water flows into the second flow channel 61 in the secondary central tube 60 under guidance of the permeate water carrier of the second functional layer 18, and flows out through the second flow channel 61.

In an embodiment, the cartridge 100 has a diameter from 1.8 inches, or 2.5 inches, or 3.0 inches to 4.0 inches, or 5.0 inches, or 6.0 inches, or 7.0 inches, or 8.0 inches. In an embodiment, the cartridge 100 has a length from 12 inches, or 13 inches, or 20 inches to 21 inches, or 30 inches, or 40 inches. In a particular embodiment, the cartridge 100 has a diameter and length combination selected from the group consisting of 1.8×12, 1.8×13, 2.0×13, 2.5×13, 2.5×20, 2.5×30, 2.5×40, 3.0×13, 3.0×20, 3.0×30, 3.0×40, 4.0×13, 4.0×21, 4.0×30, 4.0×40, 5.0×13, 5.0×21, 5.0×30, 5.0×40, 6.0×13, 6.0×21, 6.0×30, 6.0×40, 7.0×13, 7.0×21, 7.0×30, 7.0×40, 9.0×21, 8.0×30, and 8.0×40, with all dimensions being in inches.

### Experimental Data

The total dissolved solids (TDS) of feed water, permeate water and concentrate water is measured using a Myron L TDS meter (Ultrameter Model 4P).

Flowrate is measured after steady state operation by weighing permeate water/concentrate water collected in a plastic beaker during a 60 second period. The samples are measured immediately after collection without any additional treatment. For each sample, three individual measurements are averaged together to obtain the reported flowrate. The percentage of water that gets filtered is called the water recovery, measured by the ratio of permeate water flowrate and the feed water flowrate, where the feed flowrate is the sum of the permeate water flowrate and concentrate water flowrate.

### Case 1

The performance of a single-leaf side-flow reverse osmosis (SRO) cartridge was compared to a two-leaf side-flow reverse osmosis (SRO) cartridge. The single-leaf SRO cartridge has a diameter of 1.7 inches and a length of 13 inches. The two-leaf SRO cartridge has a diameter of 2.1 inches and a length of 13 inches. The single-leaf SRO cartridge and two-leaf SRO cartridge have structures as set forth below.

In Case 1, the spacer layer is a mesh spacer having a thickness of approximately 17 mils and made of polypropylene, and the permeate carrier layer is a polyester layer having a thickness of approximately 10 mils. The filtering layer is a thin film composite RO membrane having a thickness of approximately 5.3 mils. The membrane has a thin polyamide coating layer formed by interfacial polymerization on polysulfone ultrafiltration casting layer deposited on a polyester non-woven substrate.

The feedwater used had a total dissolved solids (TDS) of 500 ppm NaCl and a pH of 7. To conduct the test, the water temperature was controlled at 25° C., and the feed water pressure was 65 psi. The water recovery was set at 50%. The results of the test are shown below.

| | Single-Leaf SRO | Two-Leaf SRO |
|---|---|---|
| Permeate Flow in GPD | 75 | 156 |
| TDS Rejection (%) | 98.7 | 98.7 |

While both SRO cartridges have comparable TDS rejection, the two-leaf SRO shows more than double the flow in GPD (gallons per day) as calculated by unit conversion using the measured flow rate in ml/min.

### Case 2

The performance of a four-leaf SRO cartridge was evaluated. The four-leaf SRO cartridge has a diameter of 3.5 inches and a length of 13 inches. The four-leaf SRO cartridge has a structure consistent with that described herein having an A-B-A-B structure. In this Case 2, the membrane around an “A” leaf is composed of a permeate carrier layer having a thickness of approximately 10 mil and made of polyester, a thin film composite RO filtering layer having a thickness of approximately 5.5 mils, and a spacer layer which is a mesh spacer having a thickness of approximately 17 mils and made of polypropylene. The membrane around a “B” leaf is composed of only the permeate carrier layer having a thickness of approximately 10 mils and made of polyester and the same filtering layer as used for “A” leaf.

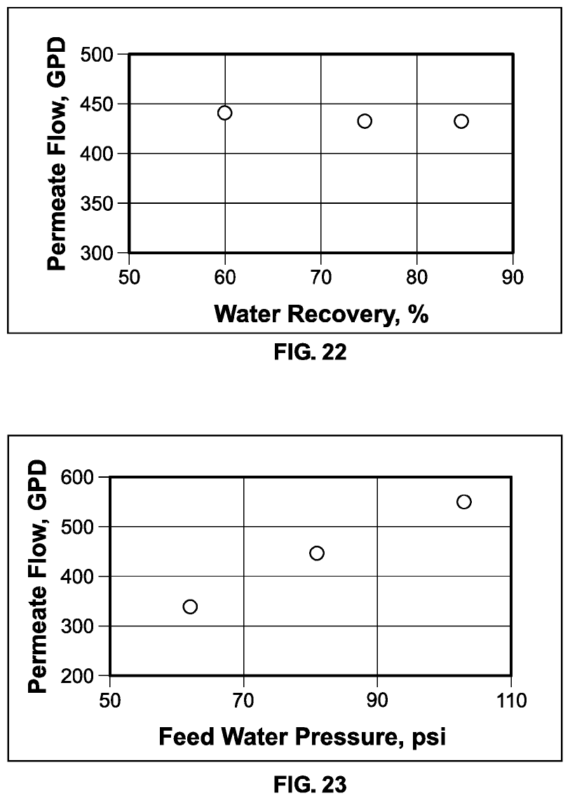

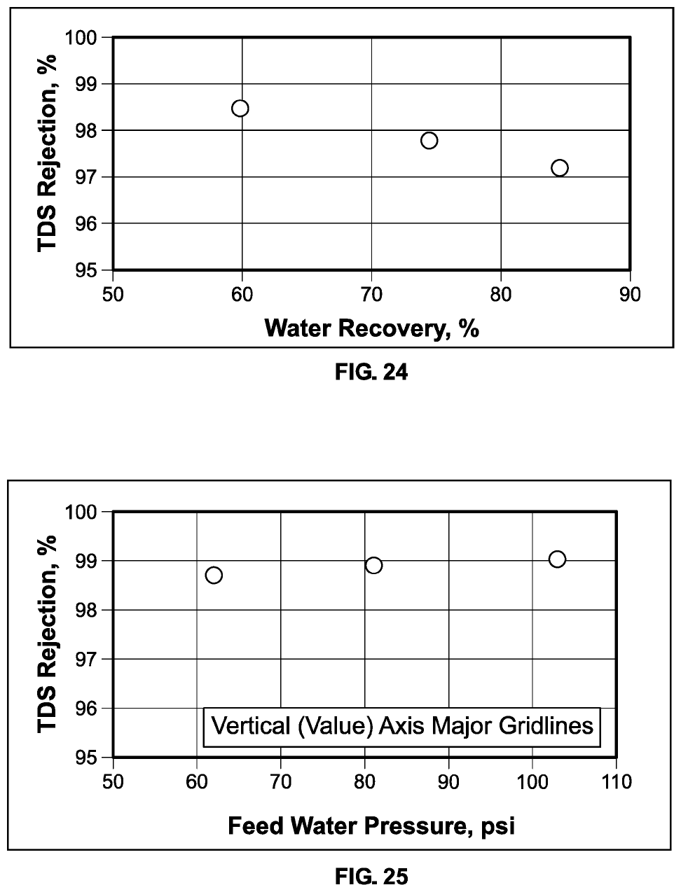

The test was conducted using an RO element test skid. The feedwater used had a total dissolved solids of 260 ppm NaCl and a pH of 7. The water temperature was 25° C. FIGS. 22 and 24 show the permeate water flow and TDS rejection, respectively, versus water recovery at fixed feed water pressure of 80 psi. FIGS. 23 and 25 show the permeate water flow and TDS rejection, respectively, versus water recovery at a fixed water recovery of 50%. The water recovery is adjusted by adjusting the concentrate water flow measured by an online flowmeter using a control valve while keeping the feed pressure constant for each recovery. The feed water pressure is adjusted by varying the pump speed and flow rate of the feed, while keeping the water recovery the same for each pressure. It can be seen that for the four-leaf SRO cartridge, the permeate flow and TDS rejection declines with water recovery, a typical phenomenon for RO elements. However, the rate of these reductions is very small. For example, as shown in FIGS. 22 and 24, the permeate flow is only reduced by 2%, from 442 GPD to 433 GPD, and TDS rejection is only reduced by 1.3%, from 98.5% to 97.2%, when water recovery is increased from 60% to 85%. This is a significant advantage of SRO over regular RO cartridges which see more significant reductions in both permeate flow and TDS as water recovery increases. Regular or standard RO cartridges refer to those with straight tangential feed flow along the cartridge length or membrane width direction and spiral flow for the permeate water, whether being single leaf or multi-leaf. For SRO, both the feed and permeate water flow in a spiral pattern along the membrane or leaf length direction, creating much higher feed entry velocity for enhanced mixing and mass transfer that helps to reduce concentration polarization, and therefore slower reduction rate in permeate flow when water recovery is increased.

As shown in FIGS. 23 and 25, when feed pressure is increased at a constant water recovery, both permeate flow and TDS rejection increase for the four-leaf SRO. This is also a common performance behavior for RO cartridges due to increased transmembrane pressure.

### Case 3

The performance of two different exemplary six-leaf SRO cartridges is compared to that of two different multi-leaf regular (comparative) RO cartridges. Again, regular or standard RO cartridges refer to those with straight feed flow along the cartridge length or membrane width direction and spiral flow for the permeate water, whether being single leaf or multi-leaf.

The exemplary six-leaf SRO cartridges each have a diameter of 4.0 inches and a length of 13 inches. The structure of the six-leaf SRO cartridges is similar to that shown herein with respect to FIG. 15, with the leaves arranged in A-B-A-B-A-B fashion. For the exemplary six-leaf SRO cartridge A, the membrane around an “A” leaf is composed of a permeate carrier layer having a thickness of approximately 10 mils and made of polyester, a thin film composite RO filtering layer having a thickness of approximately 5.7 mils, and a spacer layer which is a mesh spacer having a thickness of approximately 11 mils and made of polypropylene. The membrane around a “B” leaf is composed of only the permeate carrier layer having a thickness of approximately 10 mils and made of polyester and the same filtering layer as for the “A” leaf. The membranes of the “A” and “B” leaves of exemplary six-leaf SRO cartridge B are identical to those of exemplary six-leaf

SRO cartridge A, except in the composition and structure of the filtering layer, which is also a thin film composite RO membrane with a thickness of approximately 5.5 mils from a different manufacturer.

Comparative standard RO cartridge A′ uses a membrane having a permeate carrier layer having a thickness of approximately 9 mils and made of polyester, a filtering layer that is the same as for the 6L-SRO cartridge A, and a spacer layer which is a mesh spacer having a thickness of approximately 13 mils and made of polypropylene. Comparative A′ has a diameter of 3.0 inches and a length of 13 inches and has 10 leaves. Comparative standard RO cartridge B′ uses a membrane, permeate carrier and mesh feed spacer identical to those of the 6LOSRO cartridge B. Comparative B′ has a diameter of 3.3 inches and a length of 13 inches and has 13 leaves.

The feedwater used had a total dissolved solids of 250 ppm NaCl and a pH of 7. The water temperature was 25° C., the feed water pressure was 110 psi, and the water recovery was controlled at 70% as previously described.

| | Exemplary | Exemplary | Comparative | Comparative |
|---|---|---|---|---|
| | Cartridge A | Cartridge B | Cartridge A′ | Cartridge B′ |
| Permeate Flow | 1083 | 933 | 716 | 470 |
| in GPD | | | | |
| TDS Rejection | 97.2 | 95.1 | 95.0 | 93.5 |
| (%) | | | | |

The above results show that, while the exemplary cartridge B has 22% more membrane area than comparative cartridge B′, the permeate flow is approximately doubled. For exemplary cartridge A the effective membrane area is approximately 42% more than comparative cartridge A′, yet the flow is increased by 51%. In each case, the TDS rejection of the exemplary cartridges is higher than the corresponding comparative cartridge.

### Case 4

The longevity of a six-leaf SRO cartridge was compared to a multi-leaf regular RO cartridge. This case study was run in duplicate with two identical six-leaf SRO cartridges (“6L-SRO-1” and “6L-SRO-2”) and two identical multi-leaf regular RO cartridges (“ML-RO-1” and “ML-RO-2”) being used.

The six-leaf SRO cartridges have a diameter of 4.0 inches and a length of 1.3 inches. The six-leaf SRO cartridges are similar to that shown herein with respect to FIG. 15, with the leaves arranged in A-B-A-B-A-B fashion. The membrane around an “A” leaf is composed of a permeate carrier layer having a thickness of approximately 10 mils and made of polyester, a filtering layer of thin film composite RO membrane having a thickness of approximately 5.5 mils, and a spacer layer which is a mesh spacer having a thickness of approximately 11 mils and made of polypropylene. The membrane around a “B” leaf is composed of only the permeate carrier layer having a thickness of approximately 10 mils and made of polyester and the same filtering layer as for “A” leaf

The multi-leaf standard RO cartridges are 12-leaf cartridges having a diameter of 3.3 inches and a length of 13 inches. The membranes used in the multi-leaf standard RO cartridges is identical to the “A” leaf membranes of the six-leaf SRO cartridges.

The feed water used had a total dissolved solids of 582-680 ppm, a hardness of 233-257 ppm equivalent to calcium oxide and a pH of 7-7.5. The water temperature was 20-25° C. with a water pressure of 110 psi. The water recovery was 70%. The two six-leaf SRO cartridges and two multi-leaf standard RO cartridges were run at the same time using the same feed water. Water production capacity and TDS rejection were recorded as the tests continued. When the water production rate dropped by 40% in reference to the initial rate, the test was concluded.

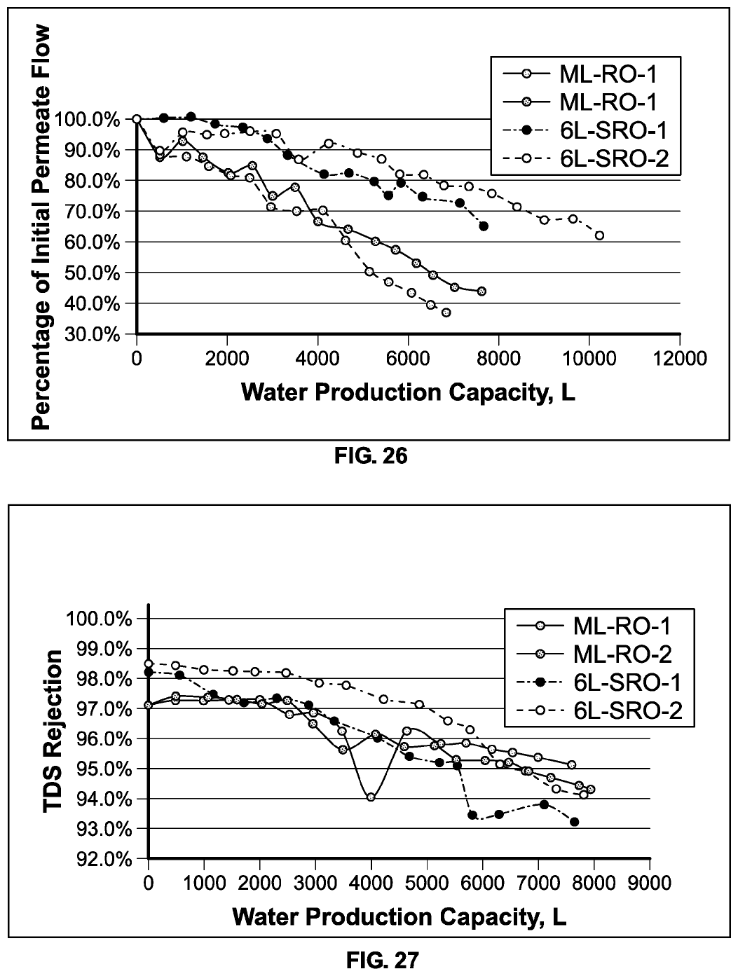

FIG. 26 shows the ratio in percentage of permeate flow to initial flow at the beginning of the longevity test versus water production capacity (time of operation). FIG. 27 shows the TDS rejection as a function of water production capacity (time of operation). The table below summarizes the results of the longevity testing.

| | ML-RO-1 | ML-RO-2 | 6L-SRO-1 | 6L-SRO-2 |
|---|---|---|---|---|
| Start Water Recovery | 70 | 72 | 70 | 71 |
| (%) | | | | |
| End Water Recovery | 48 | 46 | 58 | 66 |
| (%) | | | | |
| Water Production | 7842 | 7948 | 7643 | 10224 |
| Capacity (L) | | | | |
| Water Production at | 5249 | 4605 | 8000 | 10400 |
| 60% Initial Production | | | | |
| Rate (L) | | | | |
| Water Production Rate | 61 | 61 | 68 | 71 |
| at End (%) | | | | |
| TDS Rejection at Start | 97.2 | 97.1 | 98.2 | 98.5 |
| (%) | | | | |
| TDS Rejection at End | 95.0 | 94.3 | 93.2 | 91.2 |
| (%) | | | | |

As shown in the test results, the multi-leaf side-flow design shows significant advantages over regular multi-leaf RO designs, including maintaining water production rates, maintaining water recovery, and achieving larger amounts of production at the conclusion of the test.

It is specifically intended that the present invention not be limited to the embodiments and illustrations contained herein, but include modified forms of those embodiments including portions of the embodiments and combinations of elements of different embodiments as come within the scope of the following claims.

1. A water purification cartridge comprising:
a central core comprising at least a first pair of permeate water tubes disposed about a central channel; and
a membrane assembly wrapped around and covering the central core, the membrane assembly comprising at least a first membrane structure wrapped around a first permeate water tube, thereby creating a first permeate water tube assembly, and a second membrane structure wrapped around a second permeate water tube, thereby creating a second permeate water tube assembly, wherein the first and second membrane structures are different.

2. The water purification cartridge of claim 1, wherein the first membrane structure comprises a first functional layer, a filtering layer and a second functional layer.

3. The water purification cartridge of claim 2, wherein the first and second functional layer are different.

4. The water purification cartridge of any of claims 2-3, wherein the first functional layer is a permeate water carrier layer and the second functional layer is a feed water mesh spacer layer.

5. The water purification cartridge of any of claims 2-4, wherein the filtering layer comprises a substrate layer and a separation layer.

6. The water purification cartridge of any of claims 1-5, wherein the second membrane structure comprises a first functional layer and a filtering layer.

7. The water purification cartridge of claim 6, wherein the second membrane structure consists essentially of the first functional layer and the filtering layer.

8. The water purification cartridge of any of claims 1-7 further comprising a first end cap on a first end of the cartridge and a second end cap on the second end of the cartridge.

9. The water purification cartridge of claim 8, wherein at least one of the first end cap and second end cap comprises:
a main body having a front side and a rear side,
a permeate water outlet and a concentrate water outlet on the front side of the main body, and
a permeate water inlet and a concentrate water inlet on the rear side of the main body,
wherein the concentrate water inlet is fluidly connected with the concentrate water outlet.

10. The water purification cartridge of claim 9, wherein the permeate water outlet and concentrate water outlet are circular.

11. The water purification cartridge of claim 10, wherein the concentrate water outlet is located on the outside of the permeate water outlet.

12. The water purification cartridge of any of claims 9-11, wherein the permeate water inlet comprises multiple permeate water inlets and the concentrate water inlet is a single concentrate water inlet.

13. The water purification cartridge of claim 12, wherein the multiple permeate water inlets surround the single concentrate water inlet.

14. The water purification cartridge of any of claims 9-11, wherein the rear side of the main body has a permeate water connection column and a concentrate water connection column extending along a central axis of the end cap and having flow channels inside.

15. The water purification cartridge of claim 14, wherein each permeate water tube forms a first flow channel through the interior of the permeate water tube, wherein the central channel forms a second flow channel, and wherein the membrane assembly has an outer surface forming a third flow channel.

16. The water purification cartridge of claim 15, wherein the first flow channel is connected with the permeate water inlet and the second flow channel is connected with the concentrate water inlet.

17. The water purification cartridge of any of claims 1-16 comprising a second pair of permeate water tubes.

18. The water purification cartridge of claim 17, wherein the membrane assembly comprises at least two first membrane structures, each of the first membrane structures wrapped around a respective first permeate water tube of each of the first and second pairs of permeate water tubes, and at least two second membrane structures, each of the second membrane structures wrapped around a respective second permeate water tube of each of the first and second pairs of permeate water tubes.

19. The water purification cartridge of any of claims 1-18, wherein each of the permeate water tubes has a non-circular cross-sectional shape.

20. The water purification cartridge of claim 19, wherein the non-circular cross-sectional shape is generally a tear-drop shape.

21. The water purification cartridge of claim 20, wherein each permeate water tube has an outer wall, a front wall, an inner wall, and a back wall, wherein the outer wall and front wall taper toward one another to form a pointed transition and gradually open away from one another to meet with the back wall and inner wall, respectively, wherein the back wall is gradually rounded, and wherein the distance between the outer wall and the inner wall gradually increases from the backwall until a midpoint and then decreases at a greater rate until the inner wall transitions to the front wall.

22. The water purification cartridge of claim 21, further wherein the front wall has a contour corresponding to that of the back wall such that for two adjacent permeate water tubes the front wall of a first of the two adjacent permeate water tubes smoothly transitions to the back wall of a second of the two adjacent permeate water tubes.

23. The water purification cartridge of any of claims 1-22, wherein the central core is cylindrical.

24. A water purification cartridge comprising:
a central core comprising at least a first pair of permeate water tubes; and
a membrane assembly wrapped around and covering the central core,
wherein each of the permeate water tubes has a generally tear-drop cross-sectional shape.

25. The water purification cartridge of claim 24, comprising a second pair of permeate water tubes, each of the permeate water tubes having the same generally tear-drop cross-sectional shape as the water permeate tubes of the first pair of water permeate tubes.

26. The water purification cartridge of claims 24-25, wherein each permeate water tube has an outer wall, a front wall, an inner wall, and a back wall, wherein the outer wall and front wall taper toward one another to form a pointed transition and gradually open away from one another to meet with the back wall and inner wall, respectively, wherein the back wall is gradually rounded, and wherein the distance between the outer wall and the inner wall gradually increases from the backwall until a midpoint and then decreases at a greater rate until the inner wall transitions to the front wall.

27. The water purification cartridge of claim 26, further wherein the front wall has a contour corresponding to that of the back wall such that for two adjacent permeate water tubes the front wall of a first of the two adjacent permeate water tubes smoothly transitions to the back wall of a second of the two adjacent permeate water tubes.

28. The water purification cartridge of claims 24-27, wherein the membrane assembly comprises at least a first membrane structure wrapped around a first permeate water tube of the first pair of permeate water tubes, thereby creating a first permeate water tube assembly, and a second membrane structure wrapped around a second permeate water tube of the first pair of permeate water tubes, thereby creating a second permeate water tube assembly, and wherein the first and second membrane structures are different.
